(19) United States
(12) Patent Application Publication
(10) Pub. No.: US 2007/0103782 A1
(43) Pub. Date: May 10, 2007

(54) Binary type diffractive optical elements for wide spectral band use

(76) Inventors: Mane-Si Laure Lee, Magny-Les-Hameaux (FR); Philippe Lalanne, Palaiseau (FR); Andrew Paul Wood, Chester (GB); Christophe Sauvan, Orleans (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/576,074

(22) PCT Filed: Oct. 14, 2004
(86) PCT No.: PCT/EP04/52543

§ 371 Date: Apr. 14, 2006

(30) Foreign Application Priority Data
Oct. 15, 2003 (FR) 03 12060

(51) Int. Cl. G02B 27/44

(52) U.S. Cl. 359/565

(57) ABSTRACT

A binary type diffractive optical element for scalar optics uses a composite artificial material comprising, in a first portion Ma₁, microstructures according to a first geometry for which the effective index decreases with the fill factor and, in a second portion Ma₂, microstructures according to a second geometry for which the effective index increases with the fill factor. In one example, a composite artificial material is thus formed by hole type microstructures over a first portion, the smallest hole giving the maximum effective index value of said composite artificial material, and pillar type microstructures, the smallest pillar giving the minimum effective index value of said composite artificial material.

### FIELD OF THE INVENTION

The present invention relates to diffractive optical elements of the binary type for use in scalar optical systems, particularly for imaging in the visible and infrared ranges, in particular the thermal infrared range.

Diffractive optical elements are advantageous over refractive optical elements because they offer a non-negligible saving on size and weight and, in addition to the optical properties in common with refractive optical elements, they make it possible to correct aberrations in optical systems.

The present invention applies more particularly to the scalar domain, that is to say optics which deviate the light little or have a slowly varying phase function, with or without phase discontinuity.

The process of diffraction does not consist in simple transmission of an incident light beam in a new direction; the incident light beam is divided into a plurality of beams, each redirected at a different angle, in a particular diffraction order. The percentage of incident light redirected in a given diffraction order is the measure of the diffraction efficiency in this order. The diffraction efficiency of a diffractive optical element is determined by the surface profile of this element.

If the percentage of light which is not redirected in the desired diffraction order is substantial, this is manifested by parasitic transmitted light which is detrimental to the quality of the imaging.

To optimize the efficiency with which the incident beam is redirected toward a single diffraction order, it is necessary for the structure of the diffractive optical element to be blazed, i.e. for there to be little or no light diffracted in the orders other than the desired order, which is referred to as the blaze order.

### DESCRIPTION OF THE PRIOR ART

In conventional diffractive optical elements such as Fresnel lenses and échelette or multi-level gratings, the desired blaze effect is obtained by a progressive variation in the depth of a material having a constant index. The surface profile of these elements thus consists of continuous reliefs separated by discontinuities. These elements are designed for a certain wavelength referred to as the design wavelength, denoted λ₀.

These elements have a significant limitation in their use, because in practice they are blazed only at the design wavelength. At the design wavelength, the diffraction efficiency is 100% apart from the Fresnel losses, but the efficiency in the blaze order (1^{st} order) drops considerably as soon as the wavelength of the incident light departs from this nominal value.

This is what is represented in FIG. 1, which shows the curve of diffraction efficiency as a function of the incident wavelength for diffractive optical elements defined in the scalar domain, i.e. for elements which deviate the light little. In the scalar domain, it can in fact be shown that the diffraction efficiency as a function of the wavelength of any blazed diffractive optical element in the 1^{st} order is given by the following equation:

$$η ( λ ) = sin {c}^{2} [ π ( 1 - \frac{{λ}_{0}}{λ} ) ] \qquad Eq ( 1 )$$

where

$$sin c ( x ) = \frac{sin ( x )}{x} ,$$

for which curve 1 gives the graphical representation.

The light lost in the blaze order (1^{st} order) is transmitted in higher orders. Taking the example of a hybrid lens, this phenomenon is manifested by the transmission of parasitic light which is detrimental to the quality of the imaging. This is practically manifested by the appearance of diffracted light throughout the image plane. For example, the output image is not clean or is dull.

It can be shown that this drop in efficiency is due to the low dispersion of the material, the effect of which is that while the phase difference Δφ(λ) induced in the structure is 2π at the design or blaze wavelength λ₀, it departs from 2π when there is a small wavelength difference.

Considering the échelette grating RE represented in FIG. 2a, for example, Δφ(λ) represents the phase difference between the bottom b and the top t of an echelon e of the grating RE. This difference is equal to 2π for light incident at λ₀.

In the scalar approximation, with neglect of the Fresnel losses and assuming normal incidence of the incident beam, the phase difference Δφ(λ) as a function of the wavelength and the efficiency η(λ) as a function of the wavelength are in fact given by:

$$Δ φ ( λ ) = 2 π \frac{{λ}_{0}}{λ} \frac{Δ n ( λ )}{ Δ n ( {λ}_{0} )} \qquad Eq . ( 2 )$$

η(λ)=sin c²[π(1−Δφ(λ)/2π)], Eq.(3)
where Δn(λ)=(n(λ)−nₐᵢᵣ i.e. (n(λ)−1), for a diffractive optical element etched in a material having a refractive index n.

For these diffractive optical elements, it can be assumed that Δn(λ)=Δn(λ₀) because the dispersion of the material is negligible: the refractive index varies little around λ₀.

Eq (2) therefore becomes:

$$Δ φ ( λ ) = 2 π \frac{{λ}_{0}}{λ} \qquad Eq . ( 4 )$$

and the equation Eq(1) seen above and represented in FIG. 1 is obtained by substituting this expression for Δφ(λ) in Eq(3).

The low dispersion of the optical material in conventional diffractive optical elements thus leads to a drop in efficiency of the diffraction with the wavelength λ≠λ₀ as expressed by Eq (1). These conventional diffractive optical elements do not therefore have a wide spectral band. They cannot be used in optical systems dedicated to wide spectral band applications, such as hybrid optical systems, refractive and diffractive optical components.

Other, so-called binary microstructure diffractive optical elements are known, also referred to as a blazed binary gratings or subwavelength diffractive optical elements (SWDOE). These blazed binary gratings are in fact a binary synthesis of a conventional diffractive optical element: starting with the conventional diffractive optical element which is intended to be synthesized, this grating is sampled so as to obtain points with which an index or phase shift value can be associated. The sampling must be carried out with a period less than the design wavelength, so as to obtain a grating which functions in the subwavelength regime. The various calculation techniques used are known to the person skilled in the art, and will not be reiterated here. For an échelette blazed grating such as the grating RE represented in FIG. 2a, for example, these techniques make it possible to define a blazed binary grating as represented in FIG. 2b. Returning to FIG. 2a, two echelons of an échelette grating RE having a period Λ (or pitch of the grating) are represented. These echelons are etched in an optical material having an index n.

A blazed binary grating corresponding to the grating RE in FIG. 2a is represented in FIG. 2b. The grating RE is sampled with the period Λₛ selected to be less than the design wavelength λ₀. A certain number of points are obtained for each period A of the grating. A given fill factor for a given type of microstructure (hole, pillar) is attributed to each point: this fill factor is equal to the dimension d of the microstructure divided by the sampling period of the grating: f=d/Λₛ. The fill factor of each microstructure is defined, by known calculations, so as to locally give the sampled point a phase shift value Φ(x) which is similar to that of the echelette grating and, in the known way, is equal to

$$Φ ( x ) = 2 π ( n - 1 ) h ( x ) \frac{1}{λ}$$

where x is the coordinate of the sampled point on the axis 0x of the grating.

In the example of FIG. 2b, the binary structures are of the pillar type. A set of binary microstructures is obtained, which encode the echelon pattern of the grating. This set of microstructures is repeated with the period Λ of the echelette grating in FIG. 2a.

A fill factor f, which varies from one microstructure to another so as to follow the phase function of the échelette grating, is therefore defined for each microstructure in the synthesis operation. In the example, this dimension d increases with x over each period A of the echelette grating (for each echelon). In practice, the fill factor f of a binary microstructure of the grating can take any real value lying between 0 and 1, including the values 0 and 1. For the pillar p₀ in FIG. 2c, for example, the fill factor is 0.

FIGS. 3a and 3b represent a conventional diffractive optical element of the Fresnel lens type (FIG. 3a), and its binary synthesis by means of microstructures (FIG. 3b).

In order to describe the behavior of a binary diffractive optical element, a concept of effective index is introduced to describe the interaction of light with the microstructures. With this concept, the structure of the element is likened to a homogeneous artificial material comparable to a grating with an effective index gradient, the effective index of which varies over the period Λ (or portion) of the grating in question. FIG. 2c schematically represents a grating with an effective index gradient, corresponding to the blazed binary grating in FIG. 2b.

This concept of effective index and the analytical formulae by which it can be calculated are described in detail in various publications, among which the following may be mentioned: “On the effective medium theory of subwavelength periodic structures”, Journal of Modern Optics, 1996, vol. 43, No 10, 2063-2085 by Ph. Lalanne, D. Lemercier-Lalanne, which shows in particular the curves of variation in effective index with the fill factor and the incident wavelength (p 2078).

In practice, the effective index is a function of the fill factor f (and therefore the sampling period Λₛ), the geometry of the microstructure, the index n of the material (or, which is equivalent, its permittivity ε) and the incident wavelength λ. Various analytical formulae are thus known to the person skilled in the art which allow the curves of variation in the effective index, as a function of the fill factor f of the microstructures (and therefore as a function of d and Λₛ) and as a function of the incident wavelength λ, to be calculated for a given artificial material.

In practice, this concept is valid in all cases for which the sampling period λₛ is less than the structural cut-off value of the element, given by λ₀/n, where n is the refractive index of the optical material. The concept of a structural cut-off value is described in particular in the publication entitled “Blazed-Binary subwavelength gratings with efficiencies larger than those of conventional échelette gratings” by Ph. Lalanne, S. Astilean, P. Chavel, E. Cambril and H. Launois published in Optical Letters, vol. 23, pp 552-554 in 1998. This parameter gives the value limit of the sampling period beyond which, for any fill factor, the material no longer behaves as a homogeneous material (thin layer) and for which operation no longer takes place in the subwavelength regime. Beyond this value, there are a plurality of propagation modes and a plurality of effective indices.

There are therefore subwavelength propagation conditions with Λₛ≦λ₀, preferably under conditions in which

$${Λ}_{s} \leq \frac{{λ}_{0}}{n} .$$

In practice, Λₛ=λ₀/2 or λ₀/3 is generally selected.

Under these conditions, the blaze effect (the diffraction of incident light in a single diffraction order, the blaze order) is therefore obtained by variation of the optical index along the surface of the optical material. In fact, the microstructures are too small (subwavelength) to be resolved by the incident light (in far-field terms for diffraction) which locally perceives an average index, the effective index.

In practice, for a one-dimensional structure, the microstructures may be lines or furrows.

In a two-dimensional structure, the usual microstructures have geometries of the hole type, for example cylindrical, or pillar type, for example with a round, square or rectangular cross section. They are arranged according to a periodic grid with the sampling period Λₛ at least over the direction 0x of the surface plane of the grating. In the 2D grating example schematically represented in FIG. 4, the cell is square with dimensions Λₛₓ=Λ_{sy}=Λₛ. There is thus one microstructure per cell, for example at the center of each cell. The microstructures aligned along the direction 0x of the surface plane of the grating, such as the microstructures 101, 111, 121, 131, are assigned a fill factor varying progressively in a determined order, increasing or decreasing along the principal direction 0x of the grating.

In the case of synthesizing a grating of the échelette (or multi-level) type, the microstructures aligned along the other direction 0y of the grating, such as the microstructures 101 to 104, have an identical fill factor.

In the case (not shown here) of synthesizing zones of a Fresnel lens, the fill factor of these microstructures may vary in all directions.

These blazed binary diffractive optical elements are known to have efficiencies far superior to those of conventional optics, and they are used in the case of high-dispersion gratings and for hybrid lenses with a large numerical aperture.

### SUMMARY OF THE INVENTION

In the invention, these blazed binary elements are addressed for another reason: it has been found that the artificial material thus formed has a high dispersion, with the wavelength, of the effective refractive index seen locally at each microstructure, in contrast to the conventional diffractive optical elements for which the dispersion is the natural dispersion of the material.

The underlying idea of the invention is to exploit this high dispersion of the artificial materials in order to compensate for the variation in the diffraction efficiency as a function of the wavelength of the incident beam, with a view to obtaining diffractive optical elements blazed over a wide spectral band, i.e. diffractive optical elements which are efficient in their blaze order over a wide spectral range. In other words, the intention is to utilize this high dispersion of the artificial material in order to obtain diffractive optical elements which are quasi-achromatic and have a high diffraction efficiency.

In the invention, it has been possible to show that the use of two different geometries of microstructures, such as holes and pillars, allows this dispersion to be utilized optimally in order to compensate for the effects of the wavelength variation.

In the invention, it has been possible to identify a characteristic parameter of the resulting optical structure and define an optimization value of this parameter, for which the grating offers an optimum spectral width.

In the invention, it has thus been possible to obtain a binary diffractive optical element having a very good diffraction efficiency in the blaze order over a wide spectral band, by virtue of the dispersion properties of the artificial material.

The invention therefore relates to a diffractive optical element of the binary type with a wide spectral band, comprising binary microstructures with a variable fill factor etched on the surface of an optical material having a given index (n), forming an artificial material with an effective index gradient whose effective index varies between a minimum value and a maximum value. One optical zone of said element forms a composite artificial material comprising, in a first portion, microstructures according to a first geometry for which the effective index decreases with the fill factor and, in a second portion, microstructures according to a second geometry for which the effective index increases with the fill factor. The fill factors of these microstructures (m₁, m₂) according to the first and second geometries are defined as a function of the dispersion of said material with the wavelength in the first portion and the second portion. An element blazed over a wide spectral band is thus obtained.

According to another aspect of the invention, the minimum and maximum effective indices of said composite material are determined from curves of variation in the effective index with the fill factor of the microstructures, which are obtained at the design wavelength and at a wavelength λ_{∞} which is large compared with the design wavelength λ₀, so as to obtain an optimum value strictly greater than 0 for a characterization parameter α of said optical zone, said parameter being given by the equation:

$$α = \frac{( δ {n}_{min} - δ {n}_{max} )}{Δ n ( {λ}_{0} )} ,$$

where Δn(λ₀)=nₘₐₓ(λ₀)−nₘᵢₙ(λ₀), δnₘᵢₙ=nₘᵢₙ(λ₀)−nₘᵢₙ(λ_{∞}) and δnₘₐₓ=nₘₐₓ(λ₀)−nₘₐₓ(λ₂₈).

According to one embodiment of the invention, the diffractive optical elements may comprise one or more zones formed only by microstructures according to either the first or second geometry.

According to one embodiment of the invention, the microstructures of the first geometry type are of the hole type, and the microstructures of the second geometry type are of the pillar type.

The optical material preferably has a high refractive index n.

In an embodiment of the invention corresponding to a binary synthesis of an echelette grating having a determined period Λ, each optical zone of the microstructure corresponds to an echelon of the 6chelette grating.

In an embodiment of the invention corresponding to a binary synthesis of a Fresnel lens, each optical zone of said element corresponds to a Fresnel zone.

An optical element comprising zones of microstructures with the particular characteristics of the invention allows it to be used in systems for imaging with a wide spectral band or in a dual spectral band, in particular in infrared imaging systems, notably thermal infrared and in the visible range.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention.

Accordingly, the drawings and description thereof are to be regarded as illustrative in nature, and not as restrictive.

### BRIEF DESCRIPTION OF THE DRAWINGS

FIG. 1, already described, illustrates the diffraction efficiency of a conventional diffractive optical element, as a function of the ratio of the illumination wavelength to the nominal wavelength;

FIGS. 2a, 2b and 2c, already described, respectively illustrate a conventional echelette diffractive optical element of the 6chelette grating type, a binary synthesis of this element by means of pillar type microstructures; and the representation of a corresponding grating with an effective index gradient;

FIGS. 3a, 3b, already described, respectively illustrate a conventional diffractive optical element of the type with Fresnel lenses, and a binary synthesis of this element by means of pillar type microstructures;

FIG. 4, already described, schematically represents a 2D celled grid of binary microstructures;

FIG. 5 represents the diffraction efficiency of a binary diffractive optical element, for different values of a characterization parameter α;

FIGS. 6a and 6b illustrate, for a binary type diffractive optical element zone with cylindrical hole type microstructures (FIG. 6a), the effective index as a function of the dimension d of these microstructures divided by the sampling period, for the design wavelength and for a limit wavelength (FIG. 6b);

FIGS. 7a and 7b illustrate, for a binary type diffractive optical element zone with square pillar type microstructures (FIG. 7a), the effective index as a function of the dimension d of these microstructures divided by the sampling period, for the design wavelength and for a limit wavelength (FIG. 7b);

FIG. 8 illustrates the curve of effective index variation (FIG. 8a) associated with a structure having geometries according to the invention;

FIG. 9a illustrates such a structure with two geometries and FIG. 9b shows a corresponding curve of diffraction efficiency;

FIGS. 10a and 10b schematically show the synthesis, according to one embodiment of the invention, of a diffractive optical element of the echelette grating type;

FIGS. 10c and 10d schematically show the synthesis, according to one embodiment of the invention, of a diffractive optical element of the type with Fresnel lenses;

FIG. 11 shows another exemplary embodiment of a binary diffractive optical element according to the invention, produced according to a periodic grid with hexagonal cells;

FIGS. 12a to 12c illustrate various ways of fabricating such elements and

FIG. 13 shows the use of an anti-reflection layer.

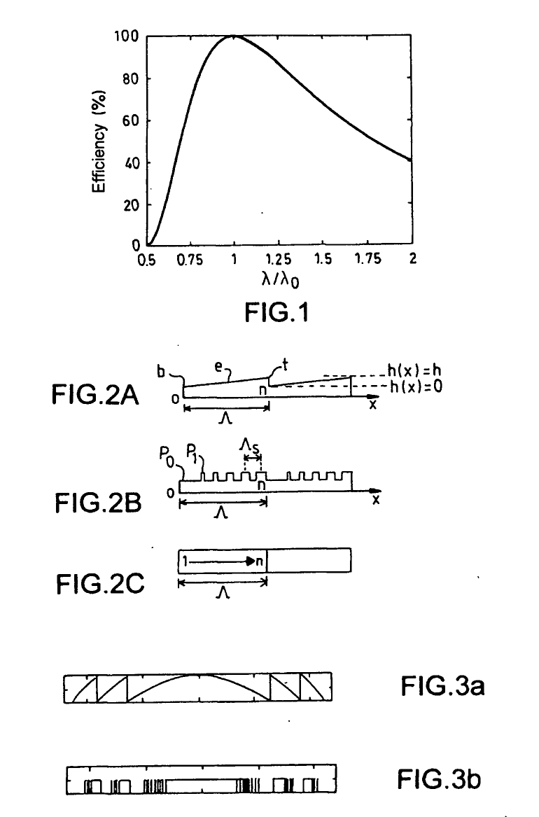

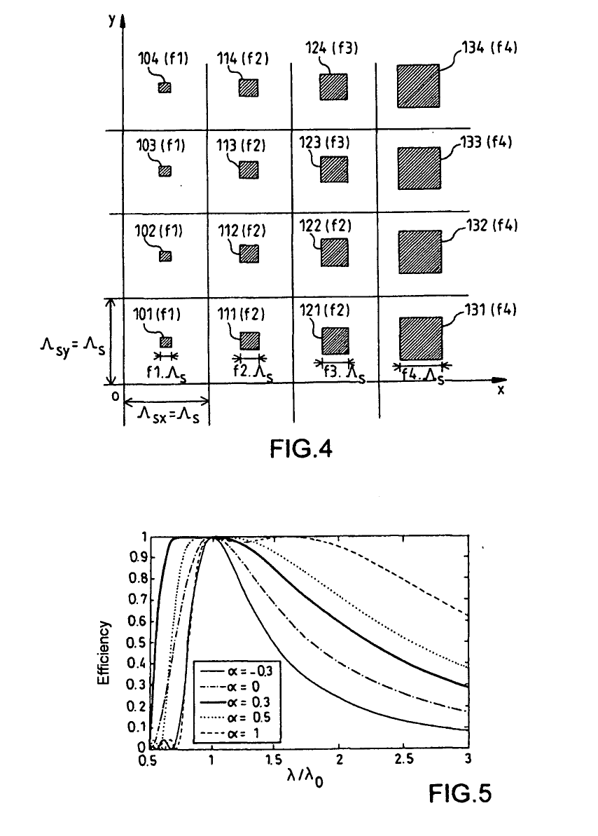

### DETAILED DESCRIPTION OF THE INVENTION

It will be recalled that the scalar domain is more particularly addressed in the invention, and that the corresponding scalar approximations and the analytical formulae defined in this domain have been used in what follows. The invention nevertheless applies beyond this domain. It makes it possible to obtain components with a wider spectral band than the components of the prior art.

These conditions having been recalled, equation Eq(2) which defines the phase difference as a function of the wavelength for the optical elements is applicable in the scalar domain. It is therefore applicable for describing the phase variation in blazed binary gratings.

It will be shown that the effective index varies non-negligibly with the wavelength. In other words, that the artificial material created from an optical material having binary microstructures of variable dimensions d, with the sampling period Λₛ, is a material with a high effective index dispersion.

It will also be shown that the phase variation given by Eq(2) as a function of the wavelength then depends on the variation in the wavelength and the variation in the effective index, and that it is possible to define a binary diffractive optical element structure in which these variations compensate for one another, so as to provide a wide spectral band element or achromatic element.

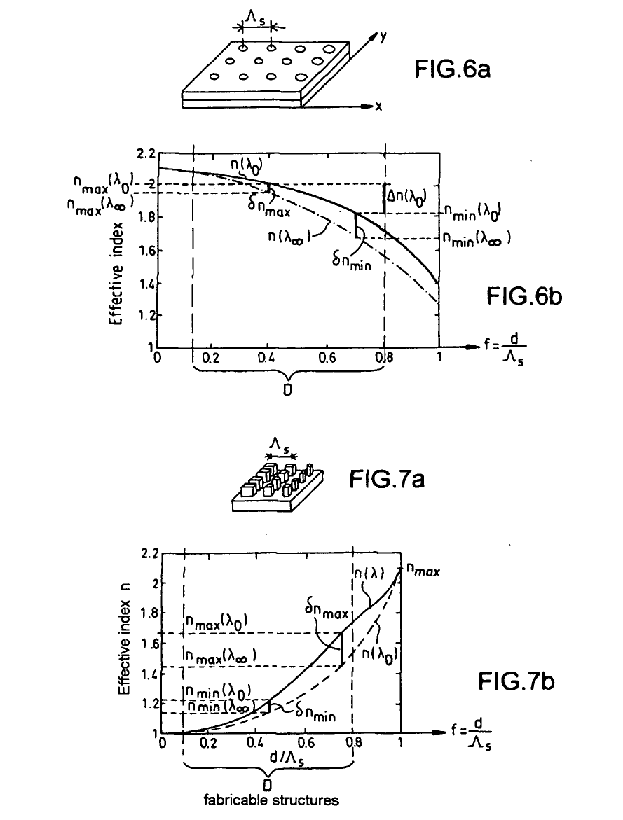

In a blazed binary diffractive optical element, for most of the fill factors associated with the microstructures, the dispersion of the effective refractive index as a function of the wavelength is in fact non-negligible, as emerges from FIGS. 6b and 7b which show the curves of variation in the effective index as a function of the fill factor f=d/Λₛ of the microstructures of a bidimensional structure represented respectively in FIGS. 6a and 7a.

In the example of FIG. 6a, the microstructures are of the cylindrical hole type with a round cross section, of variable dimensions (diameter) d, which are arranged according to a grid with square cells of dimensions Λsₓ=Λs_{y}=Λs. In the example, Λs=λ₀/2 and the optical material has an index n=2.1 (Λs is therefore not strictly less than the structural cut-off value substantially equal to λ₀/n, i.e. λ₀/2.1 here—the practical implications will be seen below).

The solid curve corresponds to light incident at the design wavelength λ₀ and the dashed curve corresponds to light incident at an “infinite” wavelength λ_{∞}, that is to say one which is very large compared with λ₀. In the example, λ_{∞}=50λ₀.

In FIG. 7b, these are the measurement curves of the effective index as a function of the fill factor of the microstructures of a bidimensional structure represented in FIG. 7a. In this example, the microstructures are of the pillar type with a square cross section, of variable width d, arranged according to a grid with square cells of dimensions Λsₓ=Λs_{y}=Λs. In the example, Λs=λ₀/2 and the optical material has an index n=2.1.

The solid curve corresponds to light incident at the nominal (design) wavelength λ₀ and the dashed curve corresponds to light incident at an “infinite” wavelength λ_{∞}, that is to say one which is very large compared with (design) λ₀. In the example, λ_{∞}=50.λ₀.

The variation in effective index at a wavelength λ as a function of the fill factor of the microstructures in a binary optical element, for example the element represented in FIG. 6a based on hole type microstructures, or the element represented in FIG. 7a based on pillar type microstructures, can be written:
Δn(λ)=nₘₐₓ(λ)−nₘᵢₙ(λ)
where nₘₐₓ corresponds to the effective index of the artificial medium corresponding to the smallest fraction of material removed in order to produce the microstructure in question, i.e. the smallest hole (FIG. 6a) or the largest pillar (FIG. 7a), and where nₘᵢₙ corresponds to the effective index of the artificial medium corresponding to the largest fraction of material removed, i.e. the largest hole (FIG. 6a) or the smallest pillar (FIG. 7a).

The dispersion of this effective index, δnₘᵢₙ at the minimum values and δnₘₐₓ at the maximum values of this index is written:
δnₘᵢₙ=nₘᵢₙ(λ₀)−nₘᵢₙ(λ_{∞}) and
δnₘₐₓ=nₘₐₓ(λ₀)−nₘₐₓ(λ_{∞}).

For the element of FIG. 6a, in which the geometry of the microstructures is of the hole type i.e. the material is removed at the actual position of the microstructures, nₘₐₓ is thus given by the microstructure of smallest dimension d, in the example of dimension d=0.4Λₛ, and is equal to about 2.02 at λ₀ and 1.95 at λ₀=50λ₀, and nₘᵢₙ is given by the microstructure of largest dimension d, in the example of dimension d=0.7Λₛ, and is equal to about 1.82 at λ₀ and 1.66 at λ_{∞}. Therefore, δnₘᵢₙ=1.82−1.66=0.16 and δnₘₐₓ=2.02−1.95=0.07.

Here, the largest quantity of material removed corresponds to a hole of the largest dimension; the smallest quantity of material removed corresponds to a hole of smaller dimension. Thus, δnₘᵢₙ gives the dispersion of the largest hole structure and δnₘₐₓ gives the dispersion of the smallest hole structure.

These dispersions are non-negligible.

For the element of FIG. 7a, in which the geometry of the microstructures is of the pillar type, i.e. the material is removed around the position of the microstructures, nₘₐₓ is given by the microstructure of largest dimension d, in the example of dimension d=0.75Λₛ, and is equal to about 1.68 at λ₀ and 1.44 at λ_{∞}=50λ₀, and nₘᵢₙ is given by the microstructure of smallest dimension d, in the example of dimension d=0.46Λₛ, and is equal to about 1.22 at λ₀ and 1.14 at λ₂₈=50λ₀.

Therefore, δnₘᵢₙ=1.22−1.14=0.08 and δnₘₐₓ=1.68−1.44=0.24.

Here, the largest quantity of material removed corresponds to a pillar of the smallest dimension; the smallest quantity of material removed corresponds to a pillar of larger dimension. Thus, δnₘᵢₙ gives the dispersion of the smallest pillar structure and δnₘₐₓ gives the dispersion of the largest pillar structure.

These dispersions are non-negligible.

It is important to note that only the largest and smallest (non-zero) microstructures (i.e. with f (=d/Λₛ)≠0) should be taken into account in the model.

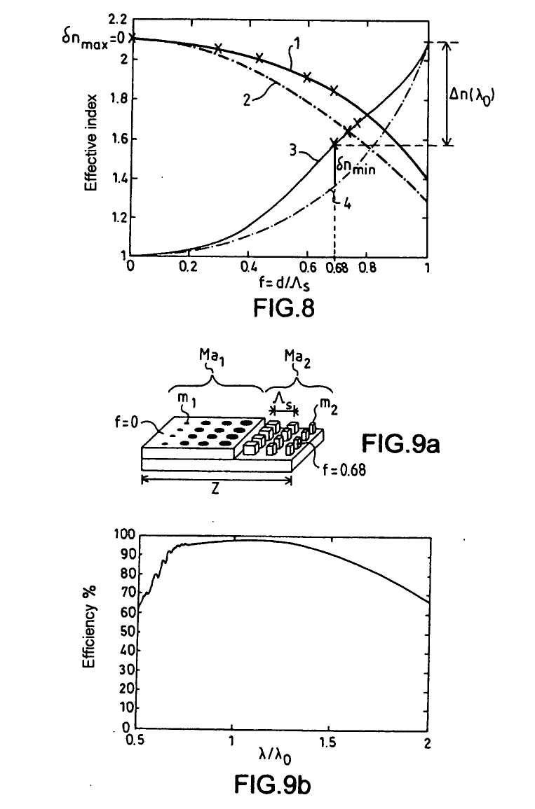

In the invention, and as represented in FIG. 8 and FIG. 9a, the idea was conceived to combine the two geometries which have inverse properties of effective index variation, in order to optimally utilize the dispersions associated with the two geometries and thus improve the spectral behavior.

Thus, as represented in FIG. 9a, the progressive variation in effective index along the direction 0x of the surface plane of the grating is obtained by encoding the low indices with microstructures of pillar type geometry, the fill factor of which increases progressively, and in encoding the higher indices with microstructures of hole type geometry, the fill factor of which decreases progressively. In the transition zone between the microstructures of hole type geometry and the microstructures of pillar type geometry, these microstructures have a fill factor of the same order of magnitude.

In practice, the hole type microstructures are obtained in the following way: a layer of material having a high index n is deposited on an optical substrate, and etched in order to form the holes. In the holes, there is air: i.e. a low index equal to 1. Elsewhere there is a high index. The artificial material Ma₁ obtained (FIG. 9a) can therefore be described as a high index material with low index insertions corresponding to the microstructures. The variation in effective index and its dispersion are represented by the curves 1 and 2 of FIG. 8.

The pillar type microstructures are obtained in the following way: a layer of material having a high index n is deposited on an optical substrate, and etched in order to remove the material except at the position of the pillars. Around the pillars, there is air. The pillars are made of a high index material. In the case of 1D line gratings, these lines can be produced directly by imprinting on the optical substrate (there is no etching in this case). The artificial material Ma₂ obtained can therefore be described as a low index material with high index insertions corresponding to the microstructures. The variation in effective index and its dispersion are represented by the curves 3 and 4 of FIG. 8.

Thus, as represented in FIG. 9a, a zone Z of a binary optical element according to the invention comprises a composite artificial material comprising a first artificial material Ma₁ comprising a high index material with insertions of low index material forming the microstructures m₁, and a second artificial material Ma₂ comprising a low index material with insertions of high index material forming the microstructures m₂, the microstructures m₁ of the first artificial material Ma₁ encoding higher values of the effective index and microstructures m₂ of the second artificial material Ma₂ encoding lower values of the effective index of the composite artificial material.

The variation and the dispersion in effective index of the composite artificial material then follows the portions of the curves 1, 2, 3, 4 as a function of the microstructures actually encoded.

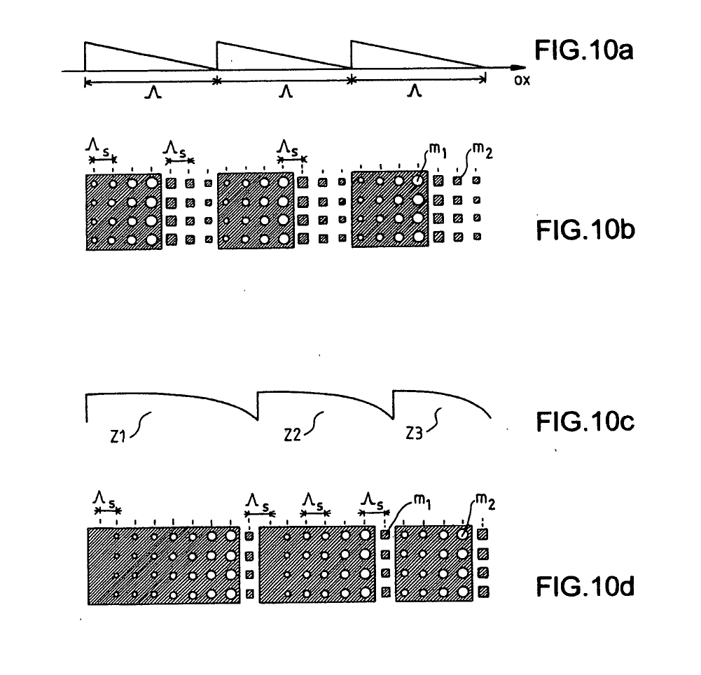

An application of the invention for synthesizing an échelette type grating of period Λ is represented in FIGS. 10a and 10b. A composite material structure is defined with a sampling period Λₛ, and this structure is repeated with the period Λ of the grating.

Another application of the invention for zones z1, z2 and z3 of a Fresnel lens is represented in FIGS. 10c and 10d. A particular composite material structure is defined for each zone with a sampling period Λₛ.

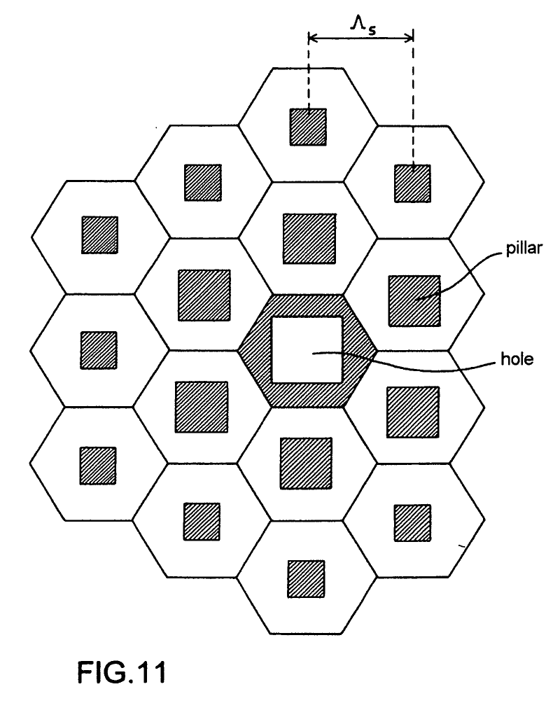

FIG. 11 shows another exemplary embodiment, in which the cell is not square but hexagonal, for encoding a zone of a Fresnel lens. A hole can be seen at the center, in the example a square hole, and pillars all around with a variable area relative to the area of the cell. The effective index thus varies in all the directions, in order to encode the phase variation of the lens.

In the case in which the cell of the grid is no longer square but rectangular, or hexagonal as in FIG. 11, or in the case in which the microstructures no longer have round or square cross sections but rectangular or other cross sections, for example, the fill factor is no longer defined as the ratio of a dimension d of the microstructure to a dimension Λₛ of the cell, but as a ratio of their respective areas: the area of the microstructure divided by the area of the cell. The appropriate definition of the fill factor will be adopted depending on the case.

There may furthermore be slight variants according to which the dimensions of one cell or another are locally modified, i.e. locally different from the sampling period, or the position of a microstructure in a cell is locally modified relative to the generic position, for example the center of the cell, with a view to optimizing the structure as much as possible.

These examples show in particular that the choice of the encoded points also depends on the phase function to be produced. In the case of the echelette grating, the phase function is linear and the fill factors of the microstructures used in the composite artificial material vary substantially linearly. For a Fresnel lens zone, this variation is no longer as “linear”.

Another important aspect of the invention is the optimization of the artificial material structures, in order to have an optimum spectral band which is as wide as possible.

Taking into account the dispersion of the effective index in the phase variation equation Eq.(2), it has been possible to show that there is a characterization parameter of the structure, which is denoted α and which is written:

$$α = \frac{( δ {n}_{min} - δ {n}_{max} )}{Δ n ( {λ}_{0} )} , \qquad Eq . ( 5 )$$

and that the equation Eq(2) of phase variation as a function of the wavelength can then be written:
Δφ(λ)=2π[(1+α)(λ₀/λ)−α(λ₀/λ)³] Eq.(6)

It has thus been possible to establish that the variation in phase with the wavelength in a blazed binary diffractive optical element depends to the first order only on a characterization parameter a of the structure.

In order to have an achromatic binary diffractive optical element, it is thus necessary to optimize the characterization parameter α which depends only on the 3 quantities δnₘᵢₙ, δnₘₐₓ and Δn(λ₀) defined above.

Studying the equation Eq.(6) shows that for α=0, the phase difference is the same as that of conventional DOEs, i.e. Δφ(λ)=2π(λ₀/λ) Eq.(4). In the case of binary structures for which the characterization parameter α is equal to 0, the efficiency of the diffraction thus follows the same the curve of variation with λ as the conventional diffractive optical elements. This is what appears in FIG. 5, which shows the curves of diffraction efficiency η(λ) as a function of the phase difference with the wavelength given by Eq.(6), for different values of α, according to the equation Eq(3) seen above:
η(λ)=sin c²[π(1−Δφ(λ)/2π)], Eq.(3)

In the invention, it is desired to solve the equation corresponding to an achromatic binary diffractive optical element, i.e. to solve Δφ(λ)=2π. This equation Δφ(λ)=2π can have a plurality of roots depending on the value of α, as represented in FIG. 5:
For α<0, the equation has only a single root λ=λ₀; the diffraction efficiency then varies even more abruptly with λ moving away from λ₀, as represented in FIG. 5 for α=−0.3. In other words, for α<0 the efficiency is more restricted than for α=0.
For α>0, the equation always has two roots λ₁≦λ₀≦λ₂. The higher the value of α, the more distant the two wavelengths λ₁ and λ₂ are. This constitutes a beneficial property in terms of bandwidth. If the 2 wavelengths are close, the phase difference will remain close to 2π at least over the spectral band delimited by λ₁ and λ₂, which means that the component is blazed over a wider spectral band than a conventional diffractive optical element. This is what is shown in FIG. 5 by the curves of diffraction efficiency as a function of the wavelength for α=0.3 and α=0.5.

In the case in which the 2 root wavelengths λ₁ and λ₂ are too far apart, the component will be blazed at two different wavelengths: there will be two working spectral bands, one around λ₁ and the other around λ₂, and the phase difference will remain close to 2π in each of these bands. This is in particular the case for α=1, the two blazed wavelengths λ₁ and λ₂ being far enough apart to be distinguished clearly.

In order to have optics as achromatic as possible, it is therefore necessary to select α>0, and preferably a as large as possible: a wide band or dual-band component is obtained. However, a cannot arbitrarily take very large values because of the limitations on the dimensions (size and height) of the microstructures, due to the fabrication constraints.

FIGS. 6b and 7b thus schematically represent the upper and lower fabrication limits. For example, for the structure of FIG. 6a composed of cylindrical holes with a round cross section distributed over a square grid and etched in a layer of silicon, the upper limit is given for dₘₐₓ≈0.8Λₛ and the lower limit is given for dₘᵢₙ26 0.13Λₛ. It will be noted that these fabrication constraints impose a limit on the smallest microstructure of non-zero dimension and on the largest structure with a fill factor not equal to 1 (d≈Λₛ). In practice, the fabrication constraints mean that a cannot be greater than one. In order to have α>1, it may be desired to minimize Δn(λ₀) which is the denominator of Eq.(5). But if Δn(λ₀) is small, then the height h of the microstructures (depth of the holes or height of the pillars) will be very great, because h is connected to Δn(λ₀) by the following relation: h=λ₀/Δn(λ₀). In other words, α>1 leads to an excessive height h which poses fabrication problems: it is not possible to etch a very small hole very deeply; it is not possible to make a pillar or a line which is very thin and very high (or thick).

Binary diffractive optical elements for which α>1 are therefore incompatible with the fabrication constraints.

It has been possible to determine, taking into account all the fabrication constraints (etching depth and minimum and maximum size of the fabricated structures), that it is possible to define optimal structures of binary diffractive optical elements for which the characterization parameter a takes a non-zero positive value (α>0).

Preferably, it is desired to have the parameter a lying between 0.3 and 0.5, preferably as close as possible to 0.5. This is because for α=0.3 and 0.5, the efficiency is more than 90% over a wide spectral band around λ₀. The value α=0.5 is a special case: this is because for this value, λ₁=λ₂=λ₀ and the slope of Δφ(λ) is zero. The variation in the phase difference around this point is therefore very slow and the efficiency has a flat maximum.

To this end, it is necessary for δnₘᵢₙ−δnₘₐₓ>0, i.e. δnₘᵢₙ>δnₘₐₓ and δnₘᵢₙ−δnₘₐₓ≧Δn(λ₀). It is therefore necessary to select the fill factors of the microstructures in an effective index zone in which the microstructures corresponding to nₘₐₓ are less dispersive than those giving nₘᵢₙ. Practically, this equates for example to selecting Δn(λ₀) by fixing nₘₐₓ=n, the index of the optical material. And the fill factor f is selected on the curve which will make it possible to have δnₘᵢₙ as large as possible, in view of the dimension limits imposed by the fabrication constraints on the dimensions d and h.

One way of optimizing a binary diffractive optical element, for a microstructure of given geometry, is therefore to select the three quantities δnₘᵢₙ, δnₘₐₓ and Δn(λ₀) so that α is strictly greater than 0 and preferably lies between 0.3 and 0.5, preferably as close as possible to 0.5.

This may be obtained by means of hole type microstructures. Returning to FIG. 6b, it is in fact seen that nₘₐₓ(λ₀) can be selected as equal to the index of the material, 2.1 in the example, encoded by a microstructure with a fill factor equal to 0, which entails δnₘₐₓ very small equal to 0; and δnₘᵢₙ may be selected to be greater than δnₘₐₓ. However, the value of δnₘᵢₙ will rapidly be limited in the delimited fabrication range D, which entails a value of nₘᵢₙ(λ₀) not very far from that of nₘₐₓ(λ₀) in view of the slope of the curve. There will then be a risk of obtaining a low value of Δn(λ₀), which entails an excessive etching depth h in order to produce the 0 to 2π phase variation function.

In the microstructures with pillar type geometry, δnₘₐₓ is necessarily large in the fabrication range D, and the value of Δn(λ₀) will be rather large in view of the slope of the curve, but it is possible to take nₘₐₓ(λ₀) equal to the index of the material, 2.1 in the example, encoded by a microstructure with a fill factor equal to 1, which entails δₙₘₐₓ very small equal to 0. In practice, however, making pillars so large will be avoided. And then, in the fabrication zone D, δₙₘᵢₙ≦δₙₘₐₓ leads to a value of a that may be negative.

In the invention, another way has been found for very satisfactorily and more easily optimizing the value of α, which consists in using two different geometries of microstructures in order to produce the variation in effective index over a period Λ of the grating to be produced.

Taking FIG. 8, on which curves 1 and 2 are the curves of FIG. 6b and curves 3 and 4 are those of FIG. 7b, it is seen that the effective indices vary inversely for these two different microstructure geometries: for holes, the effective index decreases with the fill factor; and for pillars it increases. By exploiting this characteristic, one benefits from a greater range of freedom as regards the values of the three quantities δnₘᵢₙ, δnₘₐₓ and Δn(λ₀) which define the characterization parameter α of the binary diffractive optical element.

A preferred embodiment of the invention is thus to combine two different microstructure geometries in the same element.

More precisely, it involves combining two microstructures whose profiles of variation in the effective index are the inverse of each other with the fill factor definition used in the invention. In a two-dimensional grating, for example, hole type microstructures are combined with pillar type microstructures in the same binary diffractive optical element.

By this combination of two types of structures with different geometries, and without departing from the fabrication range (dimension d and height h of the microstructures), it is quite readily possible to have a very small δnₘₐₓ and a large δnₘᵢₙ, while having a small Δn(λ₀) in order to obtain the parameter α as large as possible.

In practice, the optical material used may be glass, titanium dioxide, or silicon nitride for imaging applications in the visible range, or for example germanium or silicon for imaging applications in the infrared range.

An optical material with a high index n is preferably selected, which makes it possible to reduce the etching height h.

A method for fabricating a binary diffractive optical element structure thus comprises a step of defining a zone of this element, in which the effective index variation curves are taken (or calculated) for each of the two microstructure geometries at the design wavelength λ₀ and for a limit value denoted λ₂₈, which in practice is taken equal to 50λ₀, for example.

A point nₘₐₓ(λ₀) is then defined, preferably equal to the index of the optical material, and an attempt is made to define the point nₘᵢₙ(λ₀) so as to optimize the parameters: δnₘᵢₙ, δnₘₐₓ and Δn(λ₀).

The fabrication constraints: dimension d of the microstructures (diameter or width) and height h=λ₀/Δn(λ₀) of the microstructures determine the usable range D (not including the points corresponding to f=0 and f=1).

When the two extremes are defined, the curve portion of the composite artificial material thus defined is sampled, which comprises a curve portion associated with the hole type microstructure and a curve portion associated with the pillar type microstructure.

FIG. 8 represents the curves of variation in effective index for hole type microstructures (curves 1 and 2) and pillar type microstructures (curves 3 and 4) corresponding respectively to the curves of FIGS. 6b and 7b.

The composite material described in FIG. 9a thus has the effective index range between 1.5 and 2.1, with Λₛ=λ₀/2. Eight periods Λₛ encode the diffractive zone, which defines 8 points. The first point is encoded by f=0 with a hole type microstructure. The last point is encoded by a pillar type microstructure encoded with f=0.68.

More precisely, the zone Z of the binary diffractive optical element optimized according to the invention and represented in FIG. 9a is a zone of a binary grating having a period A equal to 25λ₀. The pattern of this zone Z is thus repeated periodically.

It was produced in silicon nitride Si₃N₄ (n=2.1) using geometries of cylindrical holes with a round cross section and pillars with a square cross section etched. In this grating, the etching depth h is 1.875λ₀ and the sampling period Λₛ is λ₀/2. The maximum effective index nₘₐₓ is encoded with the aid of holes of zero diameter (nₘₐₓ=n=2.1) and the minimum effective index nₘᵢₙ is encoded with the aid of pillars having a factor=0.68, i.e. of width d=0.34λ₀.

In this blazed binary grating with a composite artificial material, α=0.39.

The diffraction efficiency of this grating was calculated rigorously as a function of the illumination wavelength, for a grating illuminated in normal incidence with unpolarized light. This calculation was performed according to a rigorous coupled-wave analysis, RCWA, described particularly in the following article: “Formulation for stable and efficient implementation of the rigorous coupled-wave analysis of binary gratings” by M. G. Moharam, E. B. Grann, D. A. Pommet and T. K. Gaylord, published in Journal Opt. Soc. Am. A 12, 1068-1076 (1995).

The curve of diffraction efficiency as a function of the wavelength is given in FIG. 9b: a fairly wide plane zone is indeed obtained in which the diffraction efficiency is 96% and remains above 90% between 0.6λ₀ and 1.5λ₀. The diffraction efficiency does not reach 100% in practice because of the discontinuities in the surface profile when changing from one type of geometry to another. At the discontinuity, there is a shadowing effect and a phase discontinuity effect. The diffraction efficiency of this grating was calculated for a grating period Λ equal to 25λ₀. When there is a larger period, the effect of the discontinuities is less and the efficiency is therefore better. At a period of less than 25λ₀, the effect of the discontinuities is no longer significant and efficiency is lost. An inferior spectral width is obtained, but the improvement in the bandwidth may be satisfactory for certain applications. Thus, the invention is not limited to components operating in the scalar domain.

Returning to the curve of FIG. 9b, some oscillations are observed for shorter wavelengths, resulting from a multimode propagation mode. This is because at shorter wavelengths, the ratio λₛ/λ is greater than the structural cut-off value and the subwavelength microstructure can admit a plurality of propagation modes. The analogy with a homogeneous artificial medium is less and less valid for these low values of λ.

Nevertheless, FIG. 9b demonstrates well the possibility of obtaining an achromatic component with a high efficiency by virtue of the dispersion properties of the artificial media of B-DOEs.

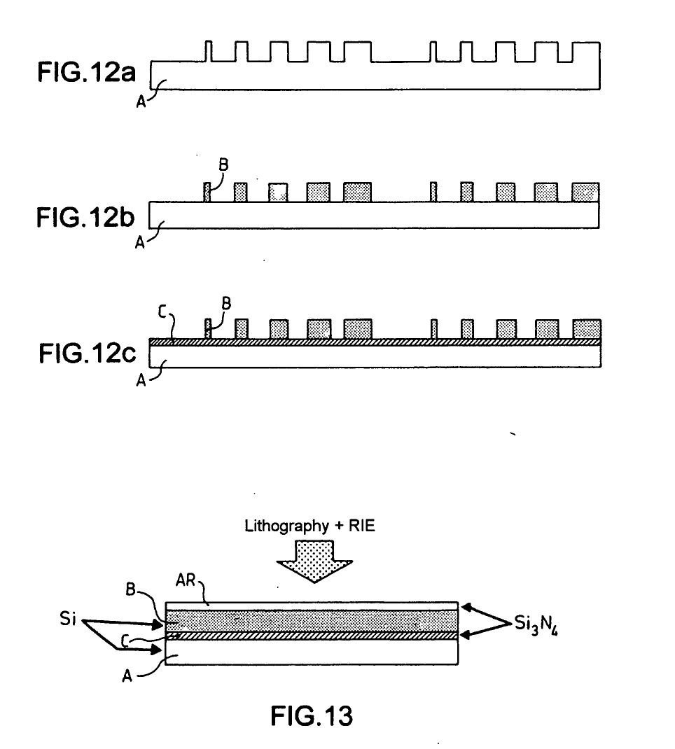

The techniques for fabricating such B-DOE elements are those of the prior art, some of which are schematized in FIGS. 12a to 12c and FIG. 13.

In FIG. 12a, the microstructures are etched in the optical substrate A. The etching height, however, is poorly controlled.

It is thus preferred, as represented in FIG. 12b, to deposit a layer of optical material B on an optical substrate A (the same material may be used for both) and etch the layer of deposited material.

A stop layer C of a different material may be provided, deposited between the substrate and the layer of material which is to be etched, as represented in FIG. 12c.

An antireflection layer AR is preferably provided on the pillars and between the holes, which may be deposited on the surface after etching the microstructures or, as represented in FIG. 13, by using a multilayer substrate formed by the base substrate A, a stop layer C, the optical layer B to be etched and an antireflection layer AR.

The invention makes it possible to use blazed binary optics for applications in a wide spectral band, that is to say with a width of the order of one octave centered on the wavelength, and in a dual spectral band, opening up very beneficial prospects of use in the field of imaging for use in the infrared, particularly the thermal infrared range, and in the visible range.

The dispersion of the effective index of the artificial materials thus makes it possible to compensate partially for the drop in efficiency with the wavelength which normally occurs in standard diffractive components. This compensation is particularly beneficial for use in composite artificial materials.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by the definition contained in the appended claims and equivalent thereof.

1-11. (canceled)

12. A diffractive optical element of the binary type, comprising: one or more optical zones, one zone comprising binary microstructures with a variable fill factor etched on the surface of an optical material having a given index, forming an artificial material with effective index variation whose effective index varies between a minimum value and a maximum value of said element, wherein one optical zone of said element forms a composite artificial material comprising, in a first portion, microstructures according to a first geometry for which the effective index decreases with the fill factor and, in a second portion, microstructures according to a second geometry for which the effective index increases with the fill factor, and the fill factors of said microstructures according to the first and second geometries are defined as a function of the dispersion of said material with the wavelength in the first portion and the second portion, so as to obtain an element blazed over a wide spectral band.

13. The optical element as claimed in claim 12, wherein the minimum and maximum effective indices of said composite material are determined from curves of variation in the effective index with the fill factor of the microstructures, which are obtained at the design wavelength and at a wavelength λ_{∞} which is large compared with the design wavelength λ₀, so as to obtain an optimum value strictly greater than 0 for a characterization parameter α of said optical zone, said parameter being given by the equation:
α=(δnₘᵢₙ−δnₘₐₓ)/Δn(λ₀), where Δn(λ₀)=nₘₐₓ(λ₀)−nₘᵢₙ(λ₀), δnₘᵢₙ=nₘᵢₙ(λ₀)−nₘᵢₙ(λ_{∞}) andδnₘₐₓ=nₘₐₓ(λ₀−nₘₐₓ(λ_{∞}),
where nₘₐₓ and nₘᵢₙ are respectively the values
where nₘₐₓ and nₘᵢₙ are respectively the values of the maximum and minimum effective index at the wavelength in question.

14. The optical element as claimed in claim 13, comprising one or more zones formed only by microstructures according to either the first or second geometry.

15. The optical element as claimed in claim 13, wherein the microstructures of the first geometry type are of the hole type, and the microstructures of the second geometry type are of the pillar type.

16. The optical element as claimed in claim 13, wherein the optical material has a high refractive index (n).

17. The optical element as claimed in claim 13, corresponding to a binary synthesis of an echelette grating having a determined period Λ, wherein each optical zone of the microstructure corresponds to an echelon of the échelette grating.

18. The optical element as claimed in claim 13, wherein each optical zone of said element corresponds to a zone of a Fresnel lens.

19. The optical element as claimed in the preceding claim, wherein the optical zone is defined to have 0.3≦α≦0.5.

20. An optical system for use in imaging with a wide spectral band or in a dual spectral band, comprising a diffractive optical element as claimed in claim 13.

21. The optical system as claimed in claim 19, for infrared imaging.

22. The optical system as claimed in claim 19, for imaging in the visible range.
